(19) United States
(12) Patent Application Publication
(10) Pub. No.: US 2009/0157273 A1
(43) Pub. Date: Jun. 18, 2009

(54) APPARATUS AND METHOD FOR CONTROLLING TRAVEL SPEED OF VEHICLE

(75) Inventors: Ryuk Kim, Gyeonggi-do (KR); Je Hun Ryu, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/323,526

(22) Filed: Nov. 26, 2008

(30) Foreign Application Priority Data
Dec. 17, 2007 (KR) 10-2007-0132838

(51) Int. Cl. G06F 7/00

(52) U.S. Cl. 701/70

(57) ABSTRACT

Disclosed herein is an apparatus and method for controlling the travel speed of a vehicle using information about a road or at least one portion thereof ahead of the vehicle. The apparatus includes a forward image sensor for photographing a forward road or portion(s) thereof, acquiring image data, and extracting information about the forward road or portion(s) from the image data using a Kalman filter. A control unit calculates a target speed required for the vehicle to travel using the forward road information. With the apparatuses and methods, vehicle safety and driving comfort can be improved.

### CROSS-REFERENCE TO RELATED APPLICATIONS

This application claims under 35 U.S.C. §119(a) priority to Korean Application No. 10-2007-0132838, filed on Dec. 17, 2007, the disclosure of which is incorporated herein by reference in its entirety.

### BACKGROUND

1. Technical Field

The present invention relates, in general, to vehicle speed control, and more particularly, to an apparatus and method for controlling the travel speed of a vehicle using information about a road ahead of the vehicle.

2. Related Art

An apparatus for controlling the travel speed of a vehicle automatically controls the vehicle speed of the vehicle depending on the steering input of a driver and the traveling conditions of the vehicle. That is, the apparatus may reduce the speed of the vehicle when the vehicle enters a curved section of the road, using information about the steering angle, yaw rate and speed of the vehicle.

A conventional apparatus for controlling the travel speed of a vehicle is a control device using the speed of a vehicle that is traveling ahead of the vehicle. That is, controlling the travel speed of a vehicle is performed on the basis of a relative speed with respect to a reference vehicle ahead of the vehicle, so that there is a problem in that the conventional vehicle speed control apparatus cannot perform its intended control function when no vehicle is traveling ahead of the vehicle.

Therefore, technology for controlling the speed of a vehicle using information about a traffic lane when the vehicle enters a curved section of the road is required even when no vehicle is traveling ahead of the vehicle.

The above information disclosed in this Background section is only for enhancement of understanding of the background of the invention and therefore it may contain information that does not form the prior art that is already known in this country to a person of ordinary skill in the art.

### SUMMARY

Accordingly, the present invention has been made keeping in mind the above problems occurring in the prior art, and an object of the present invention is to provide an apparatus and method for controlling the travel speed of a vehicle, which can detect in advance information about a road ahead of the vehicle, as well as the steering angle or yaw rate of the vehicle, so that the speed of a vehicle can be controlled when the vehicle enters or leaves a curved section of the road, thus improving the safety and riding comfort of vehicles.

In accordance with an aspect of the present invention to accomplish the above object, there is provided an apparatus for controlling a travel speed of a vehicle, comprising a forward image sensor for photographing a road or at least a portion thereof ahead of the vehicle, acquiring image data, and extracting information about the forward road or portion(s) thereof (“forward road information”) from the image data using a Kalman filter; a control unit for calculating a speed required for the vehicle to travel using the forward road information; and a driving unit for controlling a travel operation of the vehicle depending on the calculated vehicle speed.

Preferably, the forward road information may be a vehicle lateral offset from a center of a lane, a curvature of the road, a relative heading angle, a road width, and a camera tilt angle, which are extracted from lane-dividing lines of the image data and point coordinates of the lane-dividing lines, or any combination thereof.

Preferably, the forward image sensor may calculate a matrix, which parameters of the forward road information, from a gain matrix to which a weight, set in consideration of noise and probability, is applied, and calculate on the basis of both an error which actually occurs in a current calculation result and statistically estimated parameters of the forward road information in a subsequent stage, thus acquiring the forward road portion information.

In accordance with another aspect of the present invention to accomplish the above object, there is provided a method of controlling a travel speed of a vehicle, comprising acquiring image data of a road or at least a portion thereof ahead of the vehicle; extracting lane-dividing lines from the image data; extracting point coordinates of the lane-dividing lines from the extracted lane-dividing lines; calculating information about the forward road (or a portion thereof) using the point coordinates of the lane-dividing lines; determining a target speed of the vehicle using the calculated forward road information; and controlling a travel operation of the vehicle depending on the determined target speed.

Preferably, the calculating the forward road information may be performed using a Kalman filter, and the forward road information may be one of a vehicle lateral offset from a center of a lane, a curvature of the road, a relative heading angle, a road width, and a camera tilt angle, which are extracted from the lane-dividing lines of the image data and point coordinates of the lane-dividing lines, and any combination thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram showing an apparatus for controlling the travel speed of a vehicle according to the present invention;

FIG. 2 is a diagram showing a model (correlation) between a road and a forward image sensor to calculate the curvature of a forward road according to an embodiment of the present invention;

FIG. 3 is a flowchart showing a method of detecting information about a forward road;

FIG. 4 is a diagram showing an example of the extraction of lane-dividing lines using image data acquired by a forward image sensor;

FIG. 5 is a diagram showing the sequence of image coordinates in an image coordinate system;

FIG. 6 is a diagram showing a Jacobian matrix indicating matrix C; and

FIG. 7 is a diagram showing the definition of forward road information acquired by recognizing the lane-dividing lines of a forward road.

### DETAILED DESCRIPTION

Hereinafter, embodiments of the present invention will be described in detail with reference to the attached drawings.

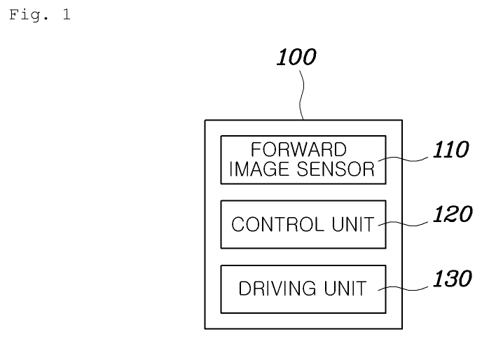

FIG. 1 is a conceptual diagram showing an apparatus for controlling the travel speed of a vehicle according to the present invention. Referring to FIG. 1, an apparatus 100 for controlling the travel speed of a vehicle includes a forward image sensor 110, a control unit 120 and a driving unit 130.

The forward image sensor 110 is installed on a front portion of a vehicle, and is configured to acquire information about a road or a portion thereof ahead of the vehicle. Here, the acquired forward road information may include a vehicle lateral offset from the center of a lane, a road width, a relative heading angle, a radius of curvature of the road, etc.

The forward image sensor 110 is placed at a predetermined height above the ground, is configured to be only vertically rotatable without being laterally or horizontally rotatable, and is set such that the central axis of the forward image sensor 110 (identical to an optical axis) is slightly tilted toward the direction of the ground. At the time of acquiring forward road information, a Kalman filter algorithm is used, which will be described later. A non-limiting example of the forward image sensor 110 may be a camera.

The control unit 120 controls the speed of the vehicle using the forward road information acquired by the forward image sensor 110. The control unit 120 sets a headway distance corresponding to the vehicle speed, determines whether to control the speed of the vehicle using the forward road information acquired by the forward image sensor 110, and calculates a speed to which the vehicle speed is to be decreased or increased.

The driving unit 130 controls the travel device of the vehicle depending on the speed determined by the control unit 120. This is well known to those skilled in the art, and thus a detailed description thereof is omitted.

Hereinafter, a method and algorithm of acquiring forward road portion information using the forward image sensor 110 will be described below with reference to the drawings.

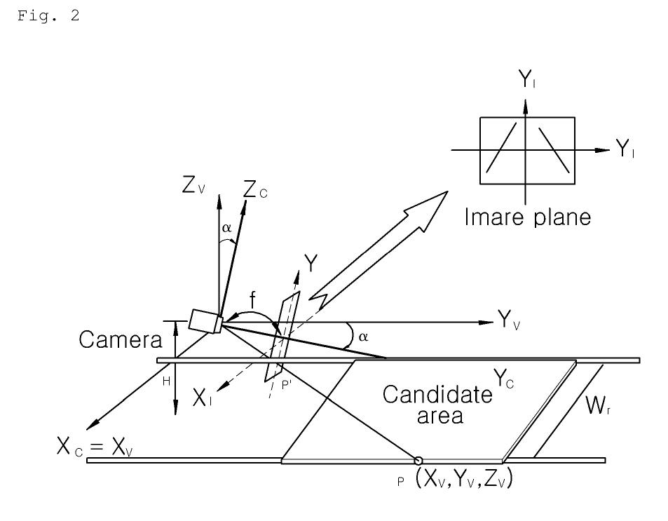

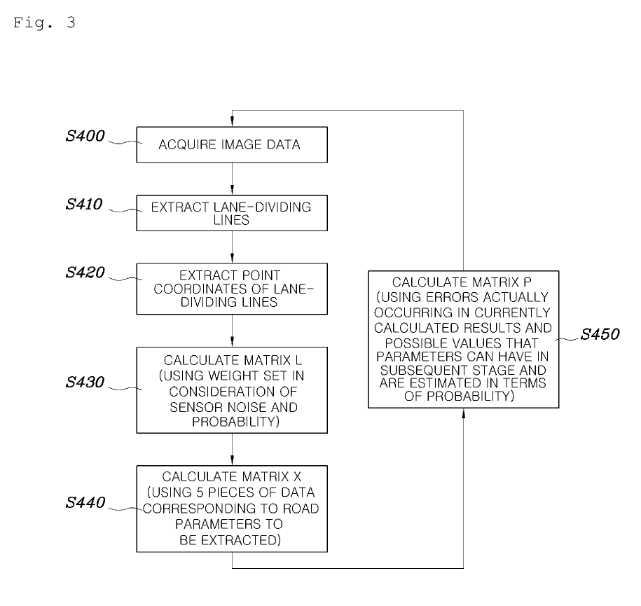

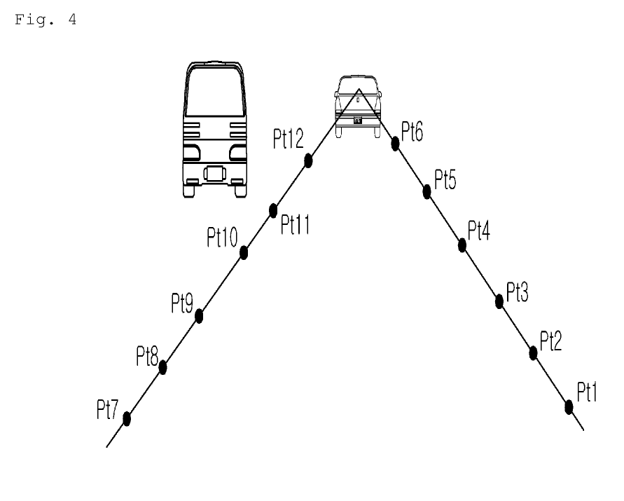

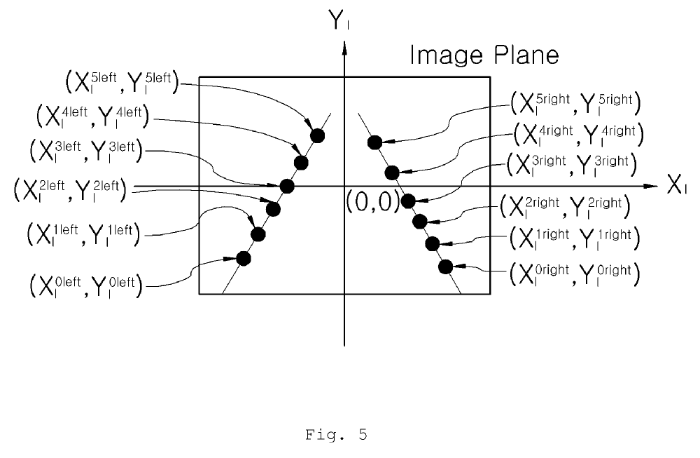

FIG. 2 is a diagram showing a model (correlation) between a road and a forward image sensor to calculate the curvature of a forward road according to an embodiment of the present invention, FIG. 3 is a flowchart showing a method of detecting forward road information, FIG. 4 is a diagram showing an example of the extraction of lane-dividing lines using image data acquired by the forward image sensor, and FIG. 5 is a diagram showing the sequence of image coordinates in an image coordinate system.

For illustration purposes only, it is assumed that the forward image sensor 110 is a camera, that the camera is located at a predetermined height (H of FIG. 2) above the ground and is only vertically rotatable, and that the central axis of the camera (identical to the optical axis thereof) is slightly tilted toward the direction of the ground.

Referring to FIG. 2, the coordinates of the vehicle relative to a road surface are indicated by Xv, Yv and Zv, the coordinates of the camera are indicated by Xc, Yc and Zc using rotational transformation, in which the conversion of a tilt angle (α of FIG. 2) is reflected, among three-dimensional rotational transformations, in order to perform coordinate transformation into the camera installed in the vehicle.

The camera includes a lens, which is an optical system, and an image plane, on which an image is formed and which is recognized as an actual image. On the basis of the image plane on which an image is ultimately obtained, X_{I} and Y_{I}, based on two-dimensional spatial coordinates, are defined.

In other words, Xv, Yv, and Zv are defined by the fixed coordinates of the vehicle relative to the road surface (vehicle fixed coordinates), Xc, Yc, and Zc are defined by the fixed coordinates of the camera (camera fixed coordinates), and X_{I} and Y_{I} are defined by image coordinates. Further, α is defined by a camera tilt angle, f is defined by a focal length, H is defined by a height of camera position, and Wr is defined by a road width.

FIG. 3 is the flowchart of a method of extracting forward road information in the road-camera model defined as shown in FIG. 2.

Two-dimensional image data is acquired by the camera at step S400, and lane-dividing lines of a lane are extracted from the acquired two-dimensional image data at step S410. Further, the point coordinates of the lane-dividing lines are extracted from the extracted lane-dividing lines at step S420. The extracted lane-dividing lines and the point coordinates thereof are shown in FIG. 4. The lane-dividing lines may be approximated to a linear equation through image processing. As shown in FIG. 4, the lane-dividing lines can be represented by two lines.

Since the lane-dividing line information acquired in this way is limited to a two-dimensional image coordinate system, the above-described information is required on the basis of road coordinates (real world coordinates) so as to actually determine whether the vehicle is offset from the center of the lane and to perform control so that the vehicle is maintained at the center of the lane. That is, on the basis of the results of recognition of the lane-dividing lines for the forward road, information about the forward road is calculated. The calculated forward road information includes a vehicle lateral offset from the center of the lane (ds), a road width (Wr), a relative heading angle (Δψ), the radius of curvature of the road (R=1/ρ), camera tilt angle (α), etc. Such forward road information may be acquired using a Kalman filter.

A calculation process using a Kalman filter is described more specifically hereinafter.

In the first stage, a matrix X, including forward road information to be extracted as parameters, is defined by the following Equation [1],

X=[ds ρ Δψ Wr α]^{T} [1]

where: ds is a vehicle lateral offset from the center of a lane, and is indicated by + when the vehicle is offset to the left and by − when the vehicle is offset to the right, and the unit of ds is meters; ρ is a road curvature and is indicated by − at the time of a right turn and by + at the time of a left turn; Δψ is a relative heading angle, which is a vehicle heading angle relative to the center of the lane, the unit of which is radians (rad); Wr is a road width, the unit of which is meters; and α is a camera tilt angle, the unit of which is radians.

In the second stage, a gain matrix L is calculated by the following Equation [2] at step S430. The matrix L is calculated in consideration of the noise of the sensor (matrix R), and includes a matrix P, indicating the range of possible values calculated in the previous stage and are obtained in terms of statistical probability,

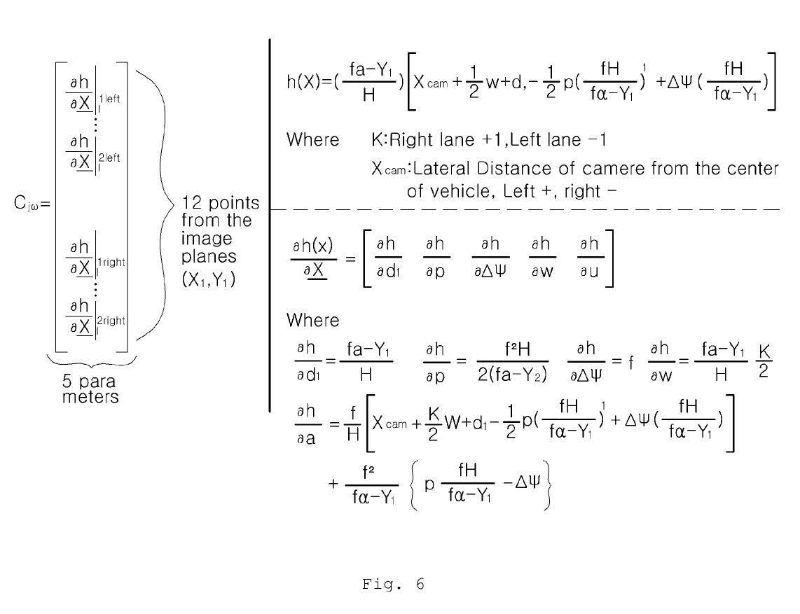

L=PC^{T}(CPC^{T}+R)⁻¹ [b 2]

where: P is the error covariance of matrix X and is a 5×5 matrix; R is an observed noise variance and is a 12×12 matrix; and C is a Jacobian Matrix, which can be represented as shown in FIG. 6.

In the third stage, the matrix is updated by the following process at step S430. In this stage, matrix L, acquired by the above Equation [2], is used. The feature of the third stage is matrix \vec{h}(X), defined by a 12×1 matrix, which is called an observation function. That is, a relational expression between image coordinates and five pieces of forward road information is defined using the road model and the five pieces of forward road information defined in the previous stage, which can be the basis for the estimation of parameters corresponding to the five pieces of forward road information from the image coordinates of the measured data, as shown in Equations [3] to [5].

Xₜ=Xₜ₋₁+L(\vec{X}₁−\vec{h}(X)) [3]

where Xₜ is a matrix including parameters for t-th forward road information, Xₜ₋₁ is a matrix including parameters for t−1-th forward road information, h(x) is an observation function, X=[ds ρ Δψ Wr α]^{T}, and the matrix L acquired using Equation [2].

In the fourth stage, the matrix is updated by the following process at step S440.

$$\overline{{X}_{I}} = [ \begin{matrix}{X}_{I}^{0 , left} \\ ⋮ \\ {X}_{I}^{5 , left} \\ {X}_{I}^{0 , right} \\ ⋮ \\ {X}_{I}^{5 , right}\end{matrix} ] \qquad [ 4 ]$$

where X̅ₜ̅ is 12×1 column vector.

$$\vec{h} ( x ) = [ \begin{matrix}( \frac{f α - {Y}_{I}^{0 , left}}{H} ) [ {X}_{cam} + \frac{k}{2} w + ds - \frac{1}{2} {ρ ( \frac{fH}{f α - {Y}_{I}^{0 , left}} )}^{2} + Δ ψ ( \frac{fH}{f α - {Y}_{I}^{0 , left}} ) ] \\ ⋮ \\ ( \frac{f α - {Y}_{I}^{5 , left}}{H} ) [ {X}_{cam} + \frac{k}{2} w + ds - \frac{1}{2} {ρ ( \frac{fH}{f α - {Y}_{I}^{5 , left}} )}^{2} + Δ ψ ( \frac{fH}{f α - {Y}_{I}^{5 , left}} ) ] \\ ( \frac{f α - {Y}_{I}^{0 , right}}{H} ) [ {X}_{cam} + \frac{k}{2} w + ds - \frac{1}{2} {ρ ( \frac{fH}{f α - {Y}_{I}^{0 , right}} )}^{2} + Δ ψ ( \frac{fH}{f α - {Y}_{I}^{0 , right}} ) ] \\ ⋮ \\ ( \frac{f α - {Y}_{I}^{5 , right}}{H} ) [ {X}_{cam} + \frac{k}{2} w + ds - \frac{1}{2} {ρ ( \frac{fH}{f α - {Y}_{I}^{5 , right}} )}^{2} + Δ ψ ( \frac{fH}{f α - {Y}_{I}^{5 , right}} ) ]\end{matrix} ] \qquad [ 5 ]$$

where \vec{h}(x) is 12×1 column vector, f is a focal length, H is a height at which the camera is mounted, and W is a road width.

In the fifth stage, error covariance matrix P, which represents a possible range of values of the parameters of the forward road information to be calculated as sensor values in the subsequent stage in terms of the statistical probability, is updated using matrices L and C obtained in the previous stages, at step S450.

Pₜ₊₁=(I−LC)Pₜ+Q [6]

where Pₜ is an error covariance at a current epoch (t), Pₜ₊₁ is an error covariance at the subsequent epoch (t+1), I is an identity matrix, and Q is a covariance matrix of system noise and is defined by a 5×5 matrix.

Subsequently, the above-described stages are repeated.

The sequence of image coordinates in the image coordinate system, used in the first to fifth stages, is shown in FIG. 5.

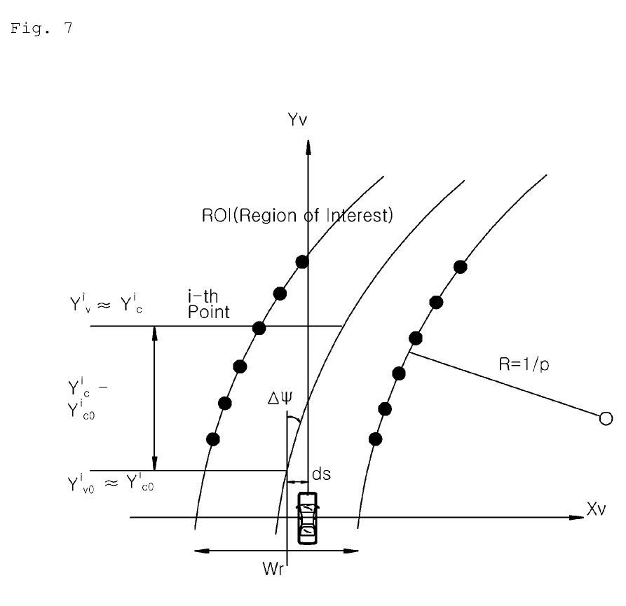

FIG. 7 is a diagram showing the definition of forward road information acquired through the recognition of the lane-dividing lines of a forward road. In FIG. 7, the parameters of the forward road information defined in the above description are shown. In order to use the curvature of the forward road, the setting of the headway distance corresponding to the speed of the vehicle is important. In this case, Yi is a Y coordinate value at an i-th point, among points recognized as lane-dividing lines on the road surface, and Yc is a Y coordinate value, measured using the camera, at the i-th point, among the points recognized as lane-dividing lines on the road surface. Further, V denotes the coordinates of the vehicle, and C denotes the coordinates of the camera, whereby variables for Y are designated, the headway distance dx is defined by the following Equation [7].

dx=V·Δt [7]

where V is the speed of the vehicle, and Δt is time. The headway distance dx is the interval from the front of the vehicle to the border between a linear section and a curved section. From this, thus, a speed required for the vehicle to move a predetermined headway distance can be calculated. That is, the speed control of the vehicle for curvature is performed by measuring a curvature value at a location corresponding to a headway distance obtained by using Equation [7], and calculating a vehicle speed corresponding to the curvature.

Meanwhile, the above-described method of controlling the travel speed of the vehicle can be implemented as a computer program. The codes and code segments constituting the program can be easily derived by computer programmers skilled in the art. Further, the program is stored in computer-readable media, and is read and executed by the computer, so that the vehicle travel speed control method is implemented. Such computer-readable media include magnetic recording media, optical recording media, and carrier wave media.

As described above, the apparatus and method for controlling the travel speed of a vehicle according to the present invention are advantageous in that vehicle safety and riding comfort can be improved.

Further, the present invention is advantageous in that, since a Kalman filter, which is a statistical prediction technique, is used, precise road information can be extracted from imprecise results of lane-dividing line recognition, thus improving the precision of speed control of the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling a travel speed of a vehicle, comprising:
a forward image sensor for photographing a road or at least a portion thereof ahead of the vehicle, acquiring image data, and extracting information about the forward road from the image data using a Kalman filter;
a control unit for calculating a speed required for the vehicle to travel using the forward road portion information; and
a driving unit for controlling a travel operation of the vehicle depending on the calculated vehicle speed.

2. The apparatus according to claim 1, wherein the forward road information is a vehicle lateral offset from a center of a lane, a curvature of the road, a relative heading angle, a road width, and a camera tilt angle, which are extracted from lane-dividing lines of the image data and point coordinates of the lane-dividing lines, or any combination thereof.

3. The apparatus according to claim 1, wherein the forward image sensor calculates a matrix, which includes parameters of the forward road information, from a gain matrix to which a weight, set in consideration of noise and probability, is applied, and calculates an error covariance matrix on the basis of both an error which actually occurs in a current calculation result and statistically estimated parameters of the forward road information in a subsequent stage, thus acquiring the forward road portion information.

4. A method of controlling a travel speed of a vehicle, comprising:
acquiring image data of a road or at least a portion thereof ahead of the vehicle;
extracting lane-dividing lines from the image data;
extracting point coordinates of the lane-dividing lines from the extracted lane-dividing lines;
calculating information about the forward road or portion thereof using the point coordinates of the lane-dividing lines;
determining a target speed of the vehicle using the calculated forward road portion information; and
controlling a travel operation of the vehicle depending on the determined target speed.

5. The method according to claim 4, wherein the calculating the information about the road or portion thereof is performed using a Kalman filter.

6. The method according to claim 4, wherein the information about the road or portion thereof is a vehicle lateral offset from a center of a lane, a curvature of the road, a relative heading angle, a road width, and a camera tilt angle, which are extracted from the lane-dividing lines of the image data and point coordinates of the lane-dividing lines, or any combination thereof.
